(19) United States
(12) Patent Application Publication
(10) Pub. No.: US 2006/0010647 A1
(43) Pub. Date: Jan. 19, 2006

(54) Framework structure

(76) Inventor: Leslie Nien, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/915,396

(22) Filed: Aug. 11, 2004

(30) Foreign Application Priority Data
Jul. 14, 2004 (TW) 093211066

(51) Int. Cl. A47H 15/00; E05D 15/06; E05D 15/16

(52) U.S. Cl. 16/106

(57) ABSTRACT

A framework structure includes a guide track, a rack body, and locking members wherein the guide track has a guide groove properly indented therein, and the rack body is equipped with a plurality of toothed protrusive flanges correspondingly tilting inwards at both lateral sides thereon to define a retaining space there-between and a plurality of clamping recesses alternatively arranged among the toothed protrusive flanges thereof. The locking member is provided with a receiving cavity properly defined thereon, and a through hole disposed at a preset position in communication with the receiving cavity thereof. Thus, in assembly, the guide track and the rack body are mutually engaged for a screen body to be mounted thereto, facilitating an easy and convenient opening/closing operation of the screen body thereof. Besides, the coupled guide track and the rack body are capable of being flexibly bent and properly arched into matched shapes relative to various kinds of the screen body such as a canopy, a mosquito net, or a blind drapery, etc., achieving widespread use of the present invention thereof.

### BACKGROUND OF THE INVENTION

The present invention is related to a framework structure, including a guide track, a rack body, and locking members wherein the guide track has a guide groove properly indented therein and the rack body is equipped with a plurality of toothed protrusive flanges tilting inwards at both lateral sides thereon to define a retaining space there-between for the guide track to be securely located therein. The locking member is provided with a receiving cavity for holding each end of the coupled guide track and the rack body thereby. In assembly, the mutually engaged guide track and the rack body are cooperatively matched to a screen body, facilitating an easy and speedy opening/closing operation of the screen body thereof. Besides, the coupled guide track and the rack body are capable of being flexibly bent or arched into matched shapes relative to various kinds of the screen body such as a canopy, a mosquito net, or a blind drapery, etc., efficiently achieving widespread use of the framework thereof.

Please refer to FIG. 1. A conventional framework for a canopy/mosquito net is made up of an integral-made and U-shaped frame body 10, a patterned decoration article 11 securely fixed at the upper side of the frame body 10 thereon, and a canopy/mosquito net 20 fixedly attached at the underside of the frame body 10 thereof. At one side of the canopy/mosquito net 20 is preset with an opening that is slightly lifted sideways to reveal an exit or entrance in practical use. However, it's quite inconvenient to go into and out of the canopy/mosquito net 20 through the small area defined by the opening thereof. Besides, the frame body 10 is integrally molded with the patterned decoration article 11 fixedly attached thereto that is unable to be flexibly replaced by a new one as desired. And due to the large volume thereof, the conventional framework tends to occupy a lot of space in the loading and delivery process. Thus, it is not only troublesome to load and deliver the framework thereof but also quite limited in the amount loaded for delivery thereof.

### SUMMARY OF THE PRESENT INVENTION

It is, therefore, the primary purpose of the present invention to provide a framework structure, including a guide track, a rack body, and locking members wherein the guide track having a guide groove defined therein is mutually registered with the rack body, and the coupled guide track and the rack body thereof are capable of being flexibly bent or properly arched into matched shapes relative to various kinds of the screen body such as a canopy, a mosquito net, or a blind drapery, etc., efficiently achieving widespread use of the framework thereof.

It is, therefore, the second purpose of the present invention to provide a framework structure wherein the guide track, the rack body, and the locking members thereof are individually made and respectively provided with smaller volume, facilitating an easier and effort-saving loading and delivery process thereof as well as occupying less space to increase the loading amount for delivery thereof.

It is, therefore, the third purpose of the present invention to provide a framework structure wherein a patterned decoration article can be detachably locked up onto the framework thereof, and the decoration article can be easily replaced with a new one of different design as desired, or simply omitted in the assembly thereof.

It is, therefore, the fourth purpose of the present invention to provide a framework structure wherein sliding units can be mounted to the guide groove of the guide track therein to cooperatively work with the screen body of various kinds so that the screen body can be adjusted to open up and locate at a certain wideness as desired, facilitating the practical use of the framework in an easier way.

### BRIEF DESCRIPTION OF THE DRAWINGS

FIG. 1 is a diagram showing the operation of a conventional framework with a canopy/mosquito net mounted thereto in practical use.

FIG. 2 is a perspective exploded view of the present invention.

FIG. 3 is a diagram showing the operation of the present invention in assembly.

FIG. 4 is a cross sectional view of the present invention in assembly.

FIG. 5 is a perspective view of another embodiment of the present invention mounted onto a window frame in assembly.

FIG. 6 is a cross sectional view of a third embodiment of the present invention mounted onto a window frame in assembly.

FIG. 7 is a cross sectional view of a fourth embodiment of the present invention mounted onto a window frame in assembly.

FIG. 8 is a cross sectional view of a fifth embodiment of the present invention mounted onto a window frame in assembly.

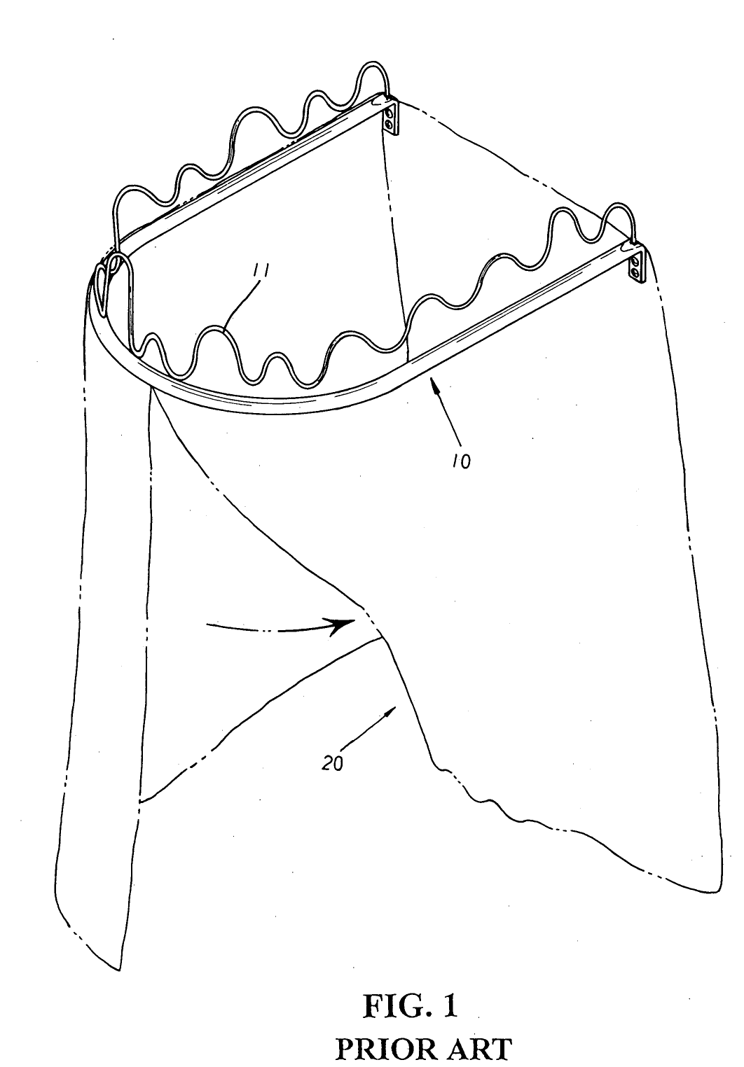

### DETAILED DESCRIPTION OF THE PREFERRED EMBODIMENTS

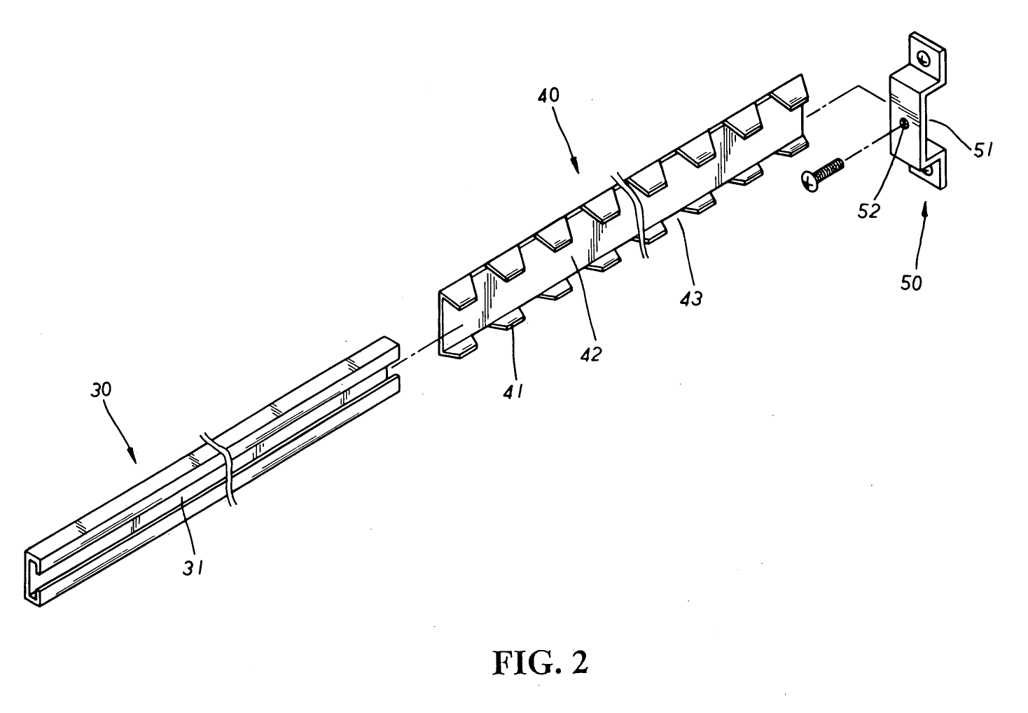

Please refer to FIG. 2. The present invention is related to a framework structure, including a guide track 30, a rack body 40, and locking members 50 wherein the guide track 30, an elongated rectangular plastic body, has a T-shaped guide groove 31 indented at a preset position therein, and the rack body 40, made of metallic material of a proper thickness to be correspondingly registered with the guide tack 30 thereby, is equipped with a plurality of toothed protrusive flanges 41 correspondingly tilting inwards at both lateral sides thereon to define a retaining space 42 there-between, and a plurality of clamping recesses 43 alternatively arranged among the toothed protrusive flanges 41 thereof. The locking member 50 is provided with a receiving cavity 51 defined at a proper position thereon, and a through hole 52 disposed at a preset position in communication with the receiving cavity 51 thereof.

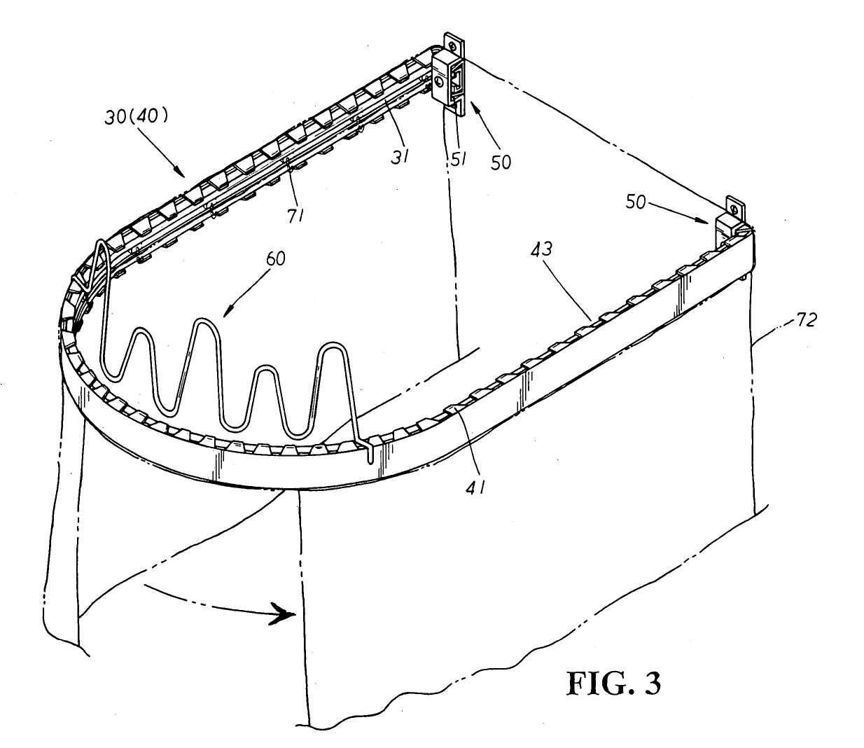

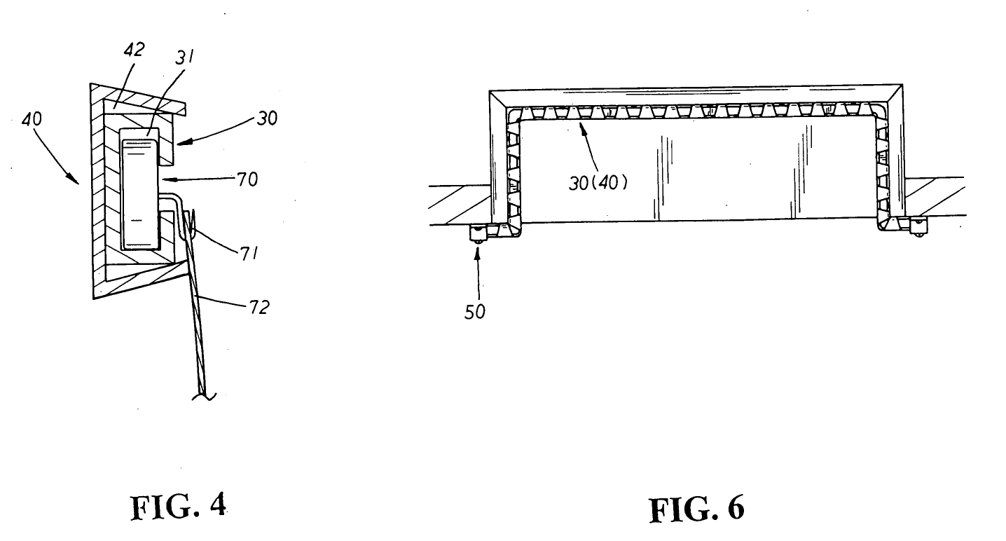

Please refer to FIGS. 3 to 4 inclusive. In assembly, the locking member 50 is securely fixed onto a wall at a proper position thereon, and the guide track 30 is led through the rack body 40 from one side thereof and properly located at the retaining space 42 therein. Via the toothed protrusive flanges 41 correspondingly tilted into a tapered angle at both lateral sides of the rack body 40 thereof, the guide track 30 is precisely clamped tight and limited at the retaining space 41 therein for secure location thereby as shown in FIG. 4. The coupled guide track 30 and the rack body 40 are properly arched at preset positions to form a U-shaped framework with both ends thereof bent inwards for a certain length to be respectively registered with the receiving cavity 51 of the locking member 50 thereof and fixedly screwed up thereto via the through hole 52 thereof. A patterned decoration article 60 is properly attached at one side of the coupled guide track 30 and the rack body 40 thereof, and sliding units 70 are mounted at the guide groove 31 of the guide track 30 therein. The sliding unit 70 is provided with a hook 71 for a screen body 72 such as a canopy or a mosquito net to be hanged thereon. In practical use, the screen body 72 of a canopy or a mosquito net is activated by the sliding units 70 to open up and locate at a proper wideness as desired, facilitating a convenient going in or out of the screen body 72 there-through as well as the opening/closing operation thereof in an easy and speedy manner.

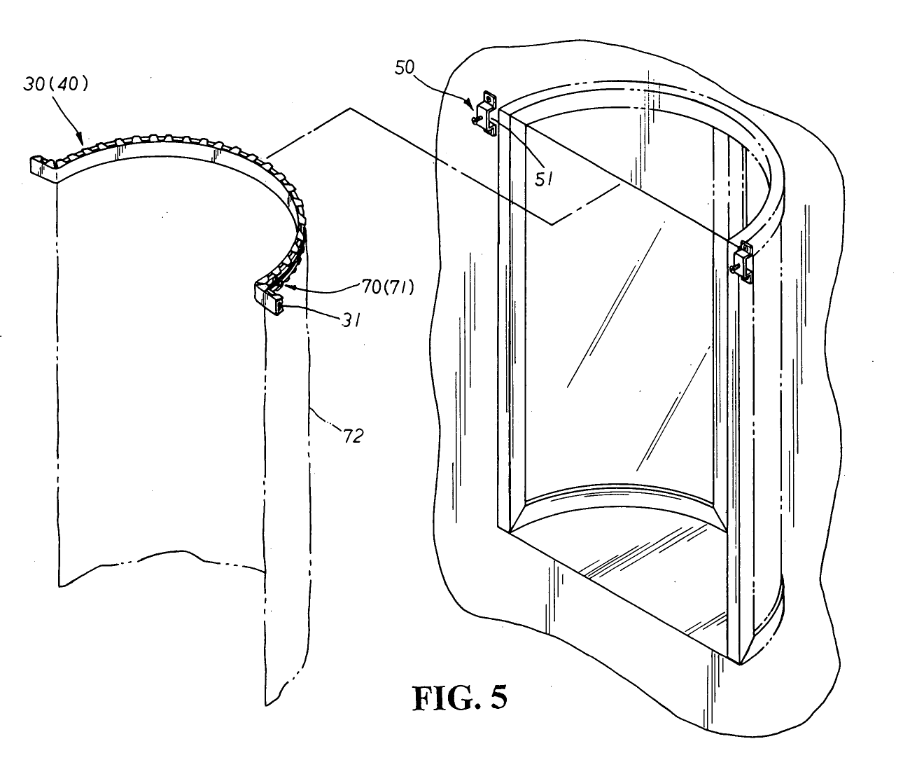

Please refer to FIG. 5. The locking member 50 can also be securely fixed onto a sidewall of a window frame at a proper position thereon, and the guide track 30 engaged with the rack body 40 thereof is bent in matched arch relative to the window frame thereof. The sliding units 70 are then mounted at the guide groove 31 of the guide track 30 therein, and the screen body 72 is hanged onto the hooks 71 thereof to suspend downwards like a window drapery. Both ends of the coupled guide track 30 and rack body 40 are respectively bent into a proper angle and for a certain length to be fixedly screwed up to the receiving cavity 51 of the locking member 50 for location therein.

Please refer to FIG. 6. The mutually engaged guide track 30 and the rack body 40 can also be bent into a matched square U-shape relative to a window frame and securely mounted thereto via the locking members 50 thereof.

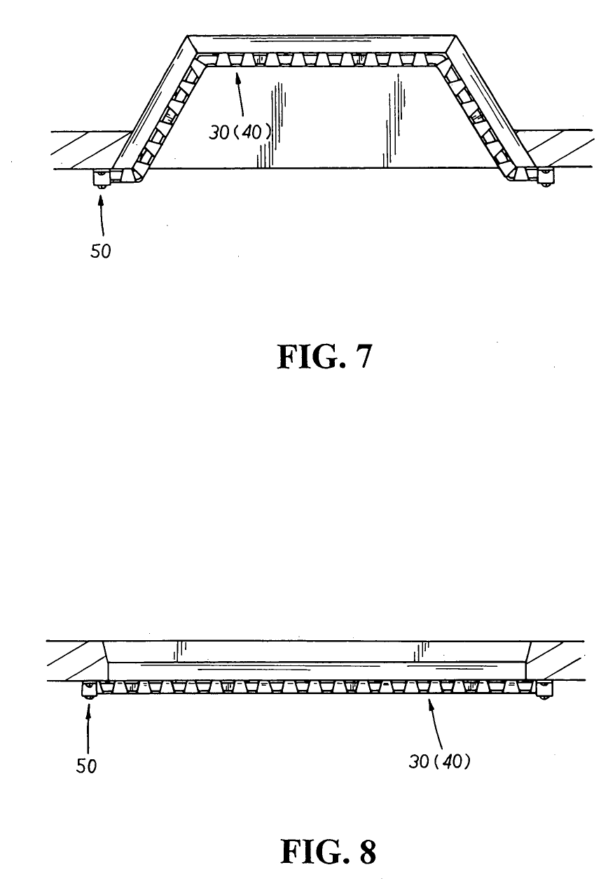

Please refer to FIG. 7. The coupled guide track 30 and the rack body 40 thereof can also be bent into a U-shaped frame with both arms slantingly expanding outwards in match to a window frame and securely mounted thereto via the locking members 50 thereof.

Please refer to FIG. 8. The guide track 30 and the rack body 40 thereof can also be formed into a straight line in match to a window frame and securely mounted thereto via the locking members 50 thereof.

What is claimed is:

1. A framework structure, including a guide track, a rack body, and locking members wherein the guide track has a guide groove properly indented therein, and the rack body is equipped with a plurality of protrusive flanges disposed at both lateral sides thereon to define a retaining space there-between and a plurality of clamping recesses alternatively arranged among the protrusive flanges thereof; the locking member is provided with a receiving cavity properly defined thereon, and a through hole disposed at a preset position in communication with the receiving cavity thereof; in assembly, the guide track and the rack body are mutually engaged and properly bent or arched into matched shapes relative to various screen bodies to achieve widespread use of the present invention thereof.

2. The framework structure as claimed in claim 1 wherein the guide track thereof is preferably made of an elongated rectangular plastic body.

3. The framework structure as claimed in claim 1 wherein the guide groove of the guide track thereof is made in a T-shaped form.

4. The framework structure as claimed in claim 1 wherein the rack body thereof is preferably made of metallic material of a proper thickness to be correspondingly registered with the guide track thereby.

5. The framework structure as claimed in claim 1 wherein the protrusive flanges disposed at both lateral sides of the rack body thereof are correspondingly tilted inwards into a tapered angle thereof.

6. The framework structure as claimed in claim 1 wherein the protrusive flanges of the rack body thereof are preferably made in toothed shapes.
